(19) United States
(12) Patent Application Publication
(10) Pub. No.: US 2022/0212695 A1
(43) Pub. Date: Jul. 7, 2022

(54) DRIVER ASSISTANCE SYSTEM FOR AN AUTONOMOUS VEHICLE

(71) Applicant: Conti Temic microelectronic GmbH, Nürnberg (DE)

(72) Inventor: Günter Anton Fendt, Schrobenhausen (DE)

(73) Assignee: Conti Temic microelectronic GmbH, Nürnberg (DE)

(21) Appl. No.: 17/594,800

(22) PCT Filed: Apr. 24, 2020
(86) PCT No.: PCT/EP2020/061455

§ 371 Date: Oct. 29, 2021

(30) Foreign Application Priority Data
Apr. 30, 2019 (DE) 10 2019 206 145.1

(51) Int. Cl. B60W 60/00; B60W 50/14; H04W 4/44

(52) U.S. Cl. CPC B60W 60/0059; B60W 50/14; B60W 2556/45; B60W 2050/143; B60W 2050/146; H04W 4/44

(57) ABSTRACT

The disclosure relates to a driver assistance system for a vehicle. The driver assistance system has an operating mode detection unit and a signaling unit. The operating mode detection unit is configured to detect whether autonomous operation of the vehicle is possible for a road section and, in case autonomous operation of the vehicle is not possible, to generate a signal and/or message taking into account stored route use data and send it to the signaling unit. The signaling unit is configured to receive the signal and to generate signaling for the driver.

The invention relates to a driver assistance system for a vehicle, a vehicle having such a driver assistance system, a method for signaling a non-autonomous road section operating mode, a program element, and a computer-readable medium.

Autonomous driving operation is usually only possible on certain road sections. These road sections have vehicle communication devices which assist in controlling the vehicles. For example, traffic sign information such as speed, light signs, incidents on the route, route conditions, etc. are transmitted to the vehicle or signals are sent from the vehicle to the communication infrastructure, such as, for example, planned turning or passing maneuvers or route data identified by the vehicle. It can occur that these vehicle communication devices are not operational such that the vehicle cannot switch to autonomous operation.

It is the object of the invention to propose a method and a device for increasing safety during autonomous driving.

The object is achieved by the subject-matter of the independent claims. Advantageous embodiments are the subject-matter of the dependent claims, the following description, and the figures.

The described embodiments similarly relate to the method for signaling a non-autonomous road section operating mode, the driver assistance system, the vehicle, the computer program element, and the computer-readable medium. Synergy effects may arise from various combinations of the embodiments even if they may not be described in detail.

It should further be noted that all embodiments of the present invention relating to a method can be carried out in the described order of the steps, although this order is not necessarily the only or the essential order of the method steps. The method presented here can be carried out with another order of the disclosed steps without deviating from the respective embodiment of the method unless explicitly stated otherwise in the following.

Technical terms are used with the meaning known to a person skilled in the art. If certain terms are assigned a certain meaning, definitions of terms are provided in the following in which context said terms are used.

In this disclosure, the operating mode of a road section is to be understood as whether or not autonomous driving operation is possible on the road section.

According to a first aspect, a driver assistance system is provided. The driver assistance system has an operating mode detection unit and a signaling unit. The operating mode detection unit is configured to detect whether autonomous operation of the vehicle is possible for a road section and, in case autonomous operation of the vehicle is not possible, to generate a signal and/or message taking into account stored route use data and send it to the signaling unit. The signaling unit is configured to receive the signal and to generate signaling for the driver.

Therefore, aside from determining whether autonomous driving is possible on the current or subsequent road section, the operating mode detection unit has the task of determining how the route has been previously used by the vehicle. If, for example, the possible current usage deviates from the typical usage of the road section, in particular if autonomous operation is not currently possible, signaling is generated which alerts the driver to drive particularly attentively. To this end, the operating mode detection unit refers to data stored in the vehicle which the operating mode detection unit can evaluate in regard to the use of the section by the vehicle user. For example, the data can be stored in a database or in a navigation system configured for this as additional information.

According to one embodiment, the stored route use data include information about whether the road section has been exclusively autonomously driven on before and the operating mode detection unit is further configured to send the signal if the road section has been exclusively autonomously driven on before.

In particular if the user always drives the road section autonomously, they develop self-assuredness and a certain routine in their actions and driving, such that the vehicle operator completely relies on the autonomous driving operation, in particular if it is a road section which is on their daily route to work, such as, for example, a section of freeway, and is thus driven on a daily basis. At the latest, this becomes problematic if the vehicle operator erroneously relies on the vehicle already driving autonomously although, for whatever reason, the infrastructure for the autonomous driving operation has a problem and is not available for the autonomous driving operation. Therefore, the operating mode detection unit evaluates information about whether the road section has been exclusively autonomously driven on before and the operating mode detection unit is further configured to send the signal to the signaling unit if the road section has been exclusively autonomously driven on before. Furthermore, according to a further embodiment, the stored route use data include a frequency of the use of the road section by the vehicle and the operating mode detection unit is further configured to send the signal to the signaling unit when a frequency threshold is exceeded. The frequency threshold can be an absolute value or a relative value, e.g. related to a time period. The frequency threshold can, for example, be an empirically determined value which is obtained from, for example, empirical data or a study or it can be a value defined by the driver.

According to one embodiment, the operating mode detection unit is configured to detect whether autonomous operation of the vehicle is possible for a road section by carrying out communication with vehicle-external communication devices. In particular, according to a further embodiment, these vehicle-external communication devices are infrastructure devices, e.g. beacons or display panels, at or above the road which send or visually display the operating state of the road section via a radio connection. In case it is a visual indication, the operating mode detection unit detects the operating state or the operating mode of the road section via a video or image acquisition unit which evaluates the content of the video or the image and provides it to the operating mode detection unit.

According to one embodiment, the vehicle-external communication devices are further vehicles, such as, for example, oncoming vehicles which have already driven on the road section and possess knowledge of the operating mode. This option can, for example, be an additional option which allows for detection before communication with the relevant infrastructure devices is possible due to distance.

Furthermore, the operating mode can also be communicated by the operating mode detection unit via a server, for example via mobile communication. For example, the vehicle can set up a radio connection with a server via which the vehicle regularly sends navigation data to the server. The server has, for example, a database which contains the operating states of the current road section or of the road section to be driven on according to the navigation data. In particular, this has the positive effect that the driver—potentially additionally—can be warned about the non-autonomous operation in time.

According to one embodiment, the signaling unit is further configured to generate acoustic signaling and/or visual signaling, such as, for example, a voice message or an indication in the instruments or a navigation device.

According to a second aspect, a vehicle with an above-described driver assistance system is provided.

According to a third aspect, a method is provided for signaling a non-autonomous road section operating mode, the method having the following steps:
detecting whether autonomous operation of the vehicle is currently possible for a road section;
generating a signal and/or a message in case autonomous operation of the vehicle is not possible taking into account stored route use data;
sending the signal to a signaling unit; and
generating signaling by the signaling unit.

The detecting whether autonomous operation of the vehicle is currently possible for a road section takes place when, for example, the vehicle approaches a road section on which autonomous driving is usually possible. During the detection, it can be assessed, for example, whether this road section has been repeatedly and exclusively autonomously driven on in the past. If the result of this assessment is positive and the check of whether autonomous driving operation is possible on the current day is negative, the signal and/or the message is generated and sent to the signaling unit which in turn generates a warning signal for the driver of the vehicle. If the check of whether autonomous driving operation is possible on the current day is positive, the driver can instead be offered autonomous driving operation. If both the check and the assessment are negative, no action is taken until the detection device communicates with a vehicle-external communication device again.

According to a further aspect, a program element is provided which, when run on a control unit of a computer, carries out the detecting of the operating mode and/or the generating of signaling. The computer program element can be part of a computer program, although it can also be an entirely independent program. For example, the computer program element can be used to update an already existing computer program in order to achieve the present invention.

According to a further aspect, a computer-readable medium is provided on which an aforementioned program element is stored. The computer-readable medium can be considered a storage medium, such as a USB stick, a CD, a DVD, a data storage device, a hard drive, or any other medium on which a program element as described above can be contained.

In the following, exemplary embodiments of the invention are described in more detail with reference to the schematic drawings, in which:

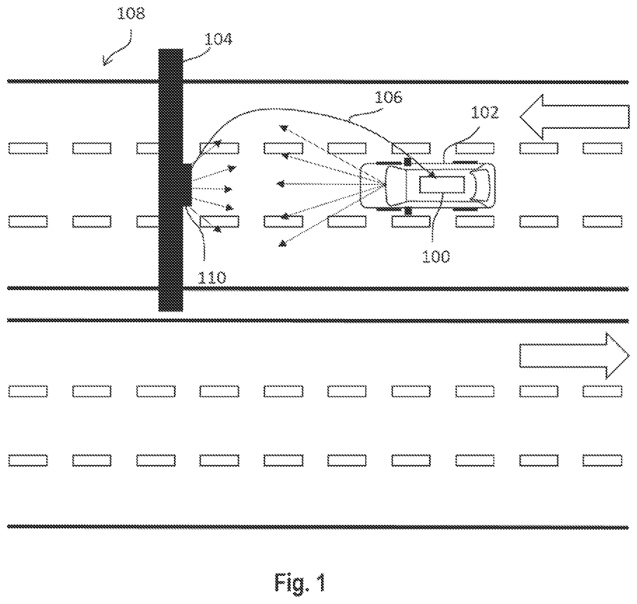

FIG. 1 shows a scenario with vehicle-to-infrastructure device communication,

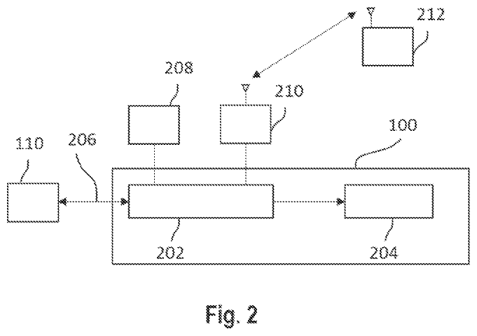

FIG. 2 shows a driver assistance system according to an exemplary embodiment,

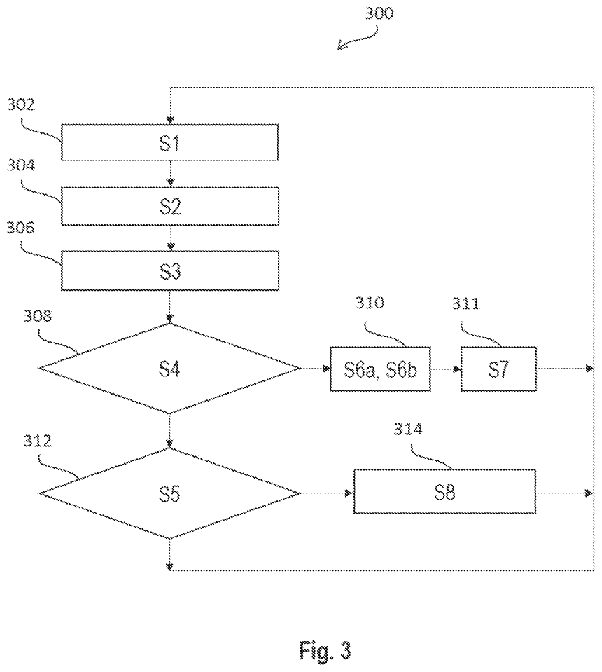

FIG. 3 shows a flow chart 300 of the method according to an exemplary embodiment.

FIG. 1 shows a scenario with vehicle-to-infrastructure device communication. The vehicle 102 approaches a road section 108 which is configured for autonomous driving. The road section 108 begins with a display panel 104 of the road infrastructure which sends signals regarding autonomous driving to the vehicle 102 via the communication device 110 or receives them from the vehicle 102. Furthermore, the vehicle 102 receives a signal 106 that there is a malfunction at the moment. Alternatively, the vehicle 102 receives no such signal, for example because the display panel is completely out of order. In this case, the driver assistance system 100 of the vehicle 102 recognizes on its own, for example using stored route use data and location data or through an image evaluation which, for example, recognizes the switched-off display panel, that no autonomous driving operation is currently possible.

FIG. 2 shows a driver assistance system 100 according to an exemplary embodiment. The driver assistance system has an operating mode detection unit 202 and a signaling unit 204. The operating mode detection unit 202 communicates with the communication device 110 via the connection 206 and is configured to detect whether autonomous operation of the vehicle 102 is possible for a road section 108. The operating mode detection unit 202 inquires whether this road section has been repeatedly and exclusively autonomously driven on in the past and checks whether autonomous driving operation is possible on the current day. To this end, the operating mode detection unit 202 can refer to an internal memory in which the frequency data of the road section use are stored, or, for example, to the memory of the navigation device 208. The navigation device 208 can also send navigation data to a server 212, via, for example, a radio communication device 210, in order to inquire about the operating mode of the road section 108 therefrom. If the result of this inquiry is positive and the result of the check is negative, the operating mode detection unit sends a signal or a message to the signaling unit 204 which generates acoustic or visual signaling, thus warning the driver.

FIG. 3 shows a flow chart 300 of the method according to an exemplary embodiment:

In step S1 302, the vehicle 102 approaches a road section 108 which is configured for autonomous driving.

In step S2 304, an assessment (A1) is carried out as to whether this road section has been repeatedly and exclusively autonomously driven on in the past.

In step S3 306, a check (P1) of whether autonomous driving operation is possible on the current day takes place.

Steps S3 and S4 can also be carried out simultaneously or in reverse order.

In step S4 308, an inquiry takes place as to whether the assessment (A1) in step S2 304 was positive and whether the check (P1) in step S3 was negative. If this condition in S4 308 is satisfied, a signal is generated and sent to the signaling unit 204 in steps S6a and S6b 310, respectively, and in step S7 311, a particular alert is generated in the vehicle 102 that no autonomous driving operation is possible. Subsequently, recourse is once again had to step S1 302.

If the condition in step S4 308 is not satisfied, it is analyzed in step S5 312 whether the check P1 from step S3 306 was positive.

If so, then, in step S8 314, autonomous driving operation is offered by the vehicle 102 and, optionally, a switch is made to autonomous driving operation according to, for example, a provided standard procedure.

If not, no action is taken and recourse is once again had to step S1 302.

Therefore, driving safety is increased in that the driver is warned by signaling that currently, in deviation from their habit, autonomous driving operation is not possible on the road section.

1. A driver assistance system comprising:
an operating mode detection unit configured to
detect whether autonomous operation of the vehicle is possible for a road section;
and, in case autonomous operation of the vehicle is not possible, generate a signal while taking into account stored route use data of the road section and send it to the signaling unit; and
a signaling unit configured to receive the signal and to generate an alert to a driver.

2. The driver assistance system according to claim 1, wherein the stored route use data of the road section include information about whether the road section has been exclusively autonomously driven on before and the operating mode detection unit is further configured to send the signal if the road section has been exclusively autonomously driven on before.

3. The driver assistance system according to claim 1, wherein the stored route use data of the road section include a frequency of the use of the road section by the vehicle and the operating mode detection unit is further configured to send the signal when a frequency threshold is exceeded.

4. The driver assistance system according to claim 1, wherein the operating mode detection unit is configured to detect whether autonomous operation of the vehicle is possible for a road section by carrying out communication with vehicle external communication devices.

5. The driver assistance system according to claim 4, wherein the vehicle external communication devices are infrastructure devices or communication devices of other vehicles.

6. The driver assistance system according to claim 1, wherein the signaling unit is further configured to generate acoustic signaling and/or visual signaling.

7. A vehicle comprising a driver assistance system, the driver assistance system comprising:
an operating mode detection unit configured to
detect whether autonomous operation of the vehicle is possible for a road section;
and, in case autonomous operation of the vehicle not possible, generate a signal while taking into account stored route use data of the road section and send it to the signaling unit; and
a signaling unit configured to receive the signal and to generate signaling an alert to a driver of the vehicle.

8. A method for signaling a non-autonomous road section operating mode, comprising:
detecting whether autonomous operation of the vehicle is possible for a road section;
generating a signal and/or a message in case autonomous operation of the vehicle is not possible taking into account stored route use data of the road section;
sending the signal to a signaling unit; and
generating an alert by the signaling unit.

9-10. (canceled)
